(19) United States
(12) Patent Application Publication
(10) Pub. No.: US 2003/0236112 A1
(43) Pub. Date: Dec. 25, 2003

(54) Electronic sequence matching game and method of game play using same

(76) Inventor: Jeffrey Breslow, Chicago, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/174,745

(22) Filed: Jun. 19, 2002

(51) Int. Cl. G06F 17/00; G06F 19/00

(52) U.S. Cl. 463/9

(57) ABSTRACT

The present invention is directed to a method of game play for an electronic sequence matching game wherein participants attempt to make selections in the correct sequential order for a sequence of a plurality of selections. The method may include providing a plurality of game figures and a plurality of receptacles adapted to receive one of the game figures, with the number of receptacles being equal to the number of selections in the sequence, determining sequence numbers associating each of the receptacles with one of the selections of the sequence, storing the sequence numbers of the receptacles, and initializing a counter to an initial value. The method of game play may further include prompting a participant to select one of the game figures, determining whether a participant selected a game figure in the correct position in the sequence by comparing the sequence number of the receptacle corresponding to the selected game figure to the counter value, and outputting a correct selection sound corresponding to the sequence number associated with the receptacle corresponding to the selected game figure after determining that the participant selected the game figure in the correct position in the sequence. Alternatively, the method may output an incorrect selection sound corresponding to the sequence number associated with the receptacle corresponding to the selected game figure after determining that the participant selected the game figure in the incorrect position in the sequence. After the participant's selection, the meth of game play may increment the counter value after determining that the participant selected the game figure in the correct position in the sequence.

### BACKGROUND

The patent is directed to a matching game, and more particularly to an electronic sequence matching game wherein playing figures are selected by participants and sound is generated that is indicative of the selected playing figure being selected in the correct or incorrect order within the sequence.

Various electronic matching games have been previously described. For example, U.S. Pat. No. 5,906,369 to Brennan et al. discloses an electronic matching game including a plurality of primary game pieces each representative of a mother farm animal, a plurality of secondary game pieces each representative of a baby farm animal associated with one of mother farm animals, and a plurality of removable cover members for selectively concealing the identity of each of the secondary game pieces. The apparatus further includes a base assembly having a first receptacle adapted to interchangeably receive one of the primary game pieces, and further having a second receptacle adapted to interchangeably receive one of the secondary game pieces.

The base assembly includes an electronic sound generation device for producing a plurality of sounds, each sound being associated with a respective one of the primary and secondary game pieces. Each of the receptacles includes a plurality of switches coupled to the sound generating device for causing the sound generating device to produce a respective sound corresponding to a respective game piece placed on the respective receptacle. Each of the game pieces includes selectively located projections for selectively engaging selected switches which correspond to the respective sound for the game piece.

In a method of game play, game play proceeds by selecting and placing one of the primary game pieces, i.e. mother farm animals, into a receptacle on the base assembly wherein the base assembly generates a first sound corresponding to the respective mother farm animal, randomly selecting one of the concealed secondary game pieces, i.e. baby farm animals, and placing the baby farm animal game piece into a receptacle on the base assembly wherein the base assembly generates a sound corresponding to the baby farm animal. The object of the game is to match the concealed baby animals to the mother animal by matching the sounds of each of the game pieces.

### SUMMARY OF THE INVENTION

In one aspect, the invention is directed to an electronic sequence matching game wherein participants attempt to make selections in the correct sequential order for a sequence of a plurality of selections. The matching game may include a plurality of game figures and a plurality of receptacles each adapted to receive one of the game figures, with the number of receptacles being equal to the number of selections in the sequence. The matching game may further include a plurality of figure switches, with each figure switch being disposed within one of the receptacles. The figure switches may be adapted to detect the absence of a game figure from the corresponding receptacle. Still further, the matching game may include a speake adapted to output sound, and a controller may be operatively coupled to the plurality of figure switches and the speaker.

The controller of the matching game may be programmed to perform various functions relating to the game play of the matching game. The controller may be programmed to determine sequence numbers associating each of the receptacles with one of the selections of the sequence, and to store the sequence numbers of the figure switches. The controller may also be programmed to initialize a counter to an initial value, and to prompt a participant to select one of the game figures. After a participant selects one of the game figures, the controller may compare the sequence number associated with a figure switch detecting the absence of the corresponding game figure to the counter value to determine whether the participant selected the game figure in the correct position in the sequence. If the participant selects a game figure in the correct sequence, the controller may cause the speaker to output a correct selection sound corresponding to the sequence number associated with the figure switch of the selected game figure. Moreover, if the participant selects a game figure out of sequence, the controller may cause the speaker to output an incorrect selection sound corresponding to the sequence number associated with a figure switch of the selected figure. Still further, the controller may be programmed to increment the counter value when the controller determines that the participant selected a game figure in the correct position in the sequence.

In one alternative embodiment, the electronic sequence matching game may further include a plurality of game pieces each having a different appearance and a game board having a top surface with indicia thereon representing a plurality of spaces which the plurality of game pieces must traverse from a starting position to a finishing position during the course of a sequence matching game. In this embodiment, the controller may be programmed to cause the speaker to output a prompt sound instructing a participant to move one of the game pieces a number of spaces corresponding to the counter value after determining that the participant selected a game figure in an incorrect position in the sequence. Still further, the controller may be programmed to determine whether the counter value is equal to a maximum value corresponding to the number of selections in the sequence, and to cause the speaker to output a prompt sound instructing a participant to move one of the game pieces a number of spaces corresponding to the counter value after the controller determines that the counter value is equal to the maximum value the number of selections in the sequence. In a still further embodiment, the electronic sequence matching game may include a finish switch adapted to detect one of the game pieces being disposed thereby, with the controller being programmed to cause the speaker to output an end-of-game sound when the finish switch detects the game pieces.

In another aspect, the present invention is directed to a method of game play for an electronic sequence matching game wherein participants attempt to make selections in the correct sequential order for a sequence of a plurality of selections. The method may include providing a plurality of game figures and a plurality of receptacles adapted to receive one of the game figures, with the number of receptacles being equal to the number of selections in the sequence, determining sequence numbers associating each of the receptacles with one of the selections of the sequence, storing the sequence numbers of the receptacles, and initializing a counter to an initial value. The method of game play may further include prompting a participant to select one of the game figures, determining whether a participant selected a game figure in the correct position in the sequence by comparing the sequence number of the receptacle corresponding to the selected game figure to the counter value, and outputting a correct selection sound corresponding to the sequence number associated with the receptacle corresponding to the selected game figure after determining that the participant selected the game figure in the correct position in the sequence. Alternatively, the method may output an incorrect selection sound corresponding to the sequence number associated with the receptacle corresponding to the selected game figure after determining that the participant selected the game figure in the incorrect position in the sequence. After the participant's selection, the method of game play may increment the counter value after determining that the participant selected the game figure in the correct position in the sequence.

The method of game play may further include prompting a participant to move a game piece a number of spaces corresponding to the counter value after determining that the participant selected a game figure in an incorrect position in the sequence, or to move a game piece a maximum number of spaces when the counter value is equal to a maximum counter value. Still further, the method of game play may include outputting an end-of-game sound when a participant disposes a game piece at a finish position, and the determination may be made via a displacement sensor. Moreover, the method of game play may further include determining that a participant selected a game figure via an optical sensor.

Additional aspects of the invention are defined by the claims of this patent.

### BRIEF DESCRIPTION OF THE DRAWINGS

FIG. 1 is a perspective view of an embodiment of an electronic sequence matching game in accordance with the invention;

FIG. 2 is a top view of the game board and base of the game of FIG. 1;

FIG. 3 is a block diagram of the electronic components of the game of FIG. 1;

FIG. 4 is a cross-sectional view taken along line 4--4 of FIG. 2;

FIG. 5 is a cross-sectional view taken along line 4--4 of FIG. 2, with the bottom of a game figure placed in the receptacle;

FIG. 6 is a cross-sectional view taken along line 4--4 of FIG. 2, with the bottom of a game figure improperly placed in the receptacle;

FIG. 7 is a cross-sectional view taken along line 7--7 of FIG. 2;

FIG. 8 is a cross-sectional view taken along line 7--7 of FIG. 2, with the bottom of a game pieced placed on the finish switch;

FIG. 9 is a flowchart of an embodiment of a main routine that may be performed during the electronic sequence matching game;

FIG. 10 is a flowchart of an embodiment of routine that may be performed when a player makes an incorrect selection; and

FIG. 11 is a flowchart of an embodiment of routine that may be performed when a player completes the sequence.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

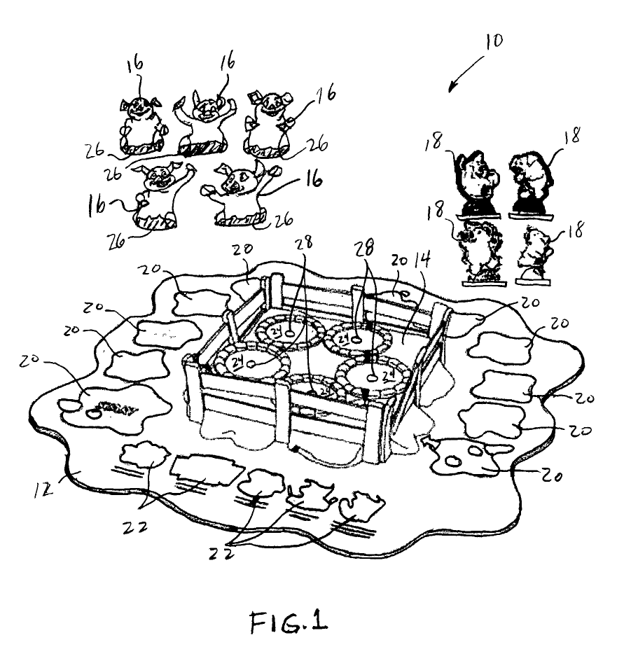

FIG. 1 illustrates one possible embodiment of an electronic sequence matching game 10 in accordance with the invention. The embodiment of the electronic sequence matching game 10 illustrated in FIG. 1 is based on the “This Little Piggy Went to Market” nursery rhyme. In this embodiment, five plastic pig figures are placed into five simulated mud holes on the game base, which is configured to resemble a pigpen. The mud holes each contain switches that detect the placement in and removal from the mud holes of the pig figures. The embodiment also includes a plurality of game pieces for use by the participants to move from the start space across the mud spot spaces to a finish switch in the pigpen. At the start of the game, each mud hole and, consequently, the pig figure inserted therein are assigned a sequence number corresponding to a line of the nursery rhyme. In this example, the sequence is as follows:

1=“This little piggy went to market”

2=“This little piggy stayed home”

3=“This little piggy had roast beef”

4=“This little piggy had none”

5=“And this little piggy cried wee wee wee all the way home”

During each participant's turn, the participant selects the pig figures by removing the figures from the mud holes. When a pig figure is selected, the switch in the corresponding mud hole detects the removal of the pig figure, and the game determines whether the pig figure has been selected in the correct sequence. If the participant makes a correct selection, the corresponding line of the nursery rhyme is played on a speaker and the participant makes another selection. If the participant makes an incorrect selection, a sound indicative of the sequence position of the selected pig figure is played on the speaker, and the participant is instructed to move his/her game piece a number of spaces on the board corresponding to the number of correct selections made by the participant during that turn. The game continues until one of the participants lands on the finish button in the pigpen. This embodiment and the drawing figures herein are exemplary only, and are not intended to limit scope of the claims to this particular embodiment. Other configurations of the electronic sequence matching game are contemplated having, for example, different configurations of the game board and game base, different figures and game pieces, including different animals, humans, or inanimate objects, different sequences, such as other nursery rhymes, song lyrics, numeric or alphanumeric sequences, and other variations that are within the scope of the claims defining the invention. Furthermore, it is contemplated the the matching game may be implemented partially or entirely through electronic and/or graphic means such that the game layout, figures and audio portions of the matching game are presented via video or audio technology.

Referring now to FIG. 1, the game 10 may include a game board 12, a base 14 which may be disposed on the game board 12, a plurality of game figures 16, and a plurality of game pieces 18. The game board 12 may include indicia 20 denoting spaces on which the game pieces are placed by the participants and across which the game pieces are moved to negotiate from a starting position to a finishing position in a manner more fully described herein. In order to assist the participants, the game board 12 may further include indicia 22 illustrating a sequence that must be matched in order to move the game pieces 18 along the indicia 20 during the course of playing the sequence matching game.

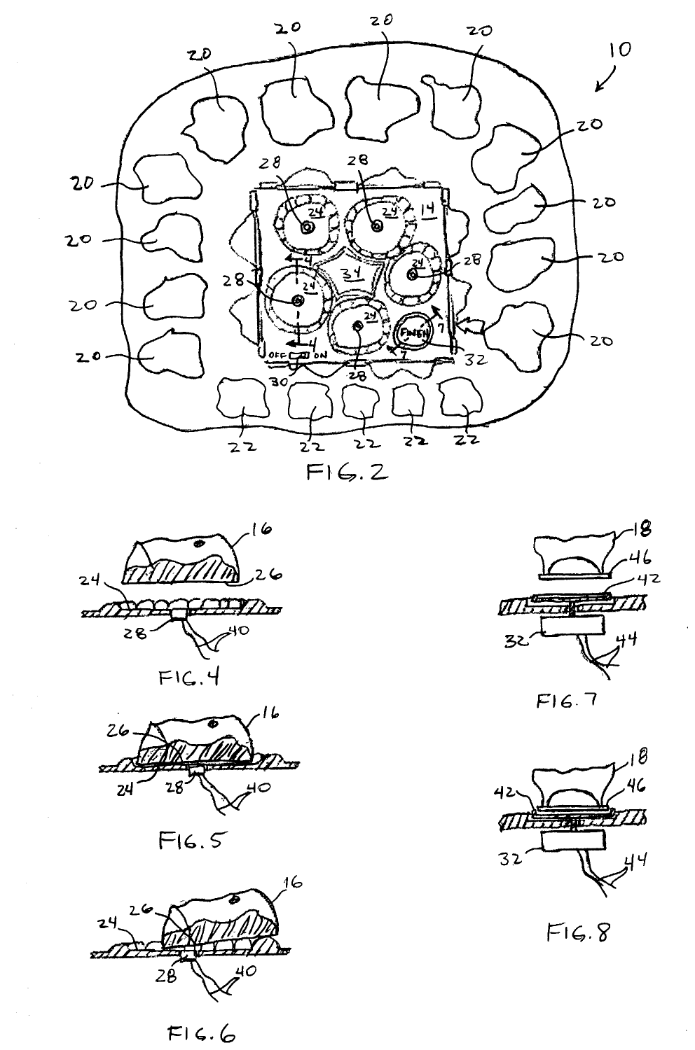

The base 14 may contain the electronic components of the game 10, the configuration of one embodiment of which is illustrated schematically in FIG. 3, which is described below. The top of the base 14 may include a plurality of receptacles 24 formed therein. The receptacles 24 may be configured to receive the bottoms 26 of the game figures 16 during the course of play of the matching game 10. Each of the receptacles 24 may include a corresponding figure switch 28. The figure switches 28 may be any type of electronic or electromechanical switch that can detect the presence of one of the game figures 16 properly disposed in the corresponding receptacle 24. During the course of game play, the figure switches 28 may detect the proper positioning of the bottoms 26 of the game figures 16 in the receptacles 24. If one or more of the game figures 16 are not positioned in receptacles 24, or are mis-aligned in the receptacles 24, the corresponding figure switches 28 will not detect the presence of the game figures, and the participants may be prompted to properly position all of the game figures 18 in the receptacles 24. Once all the game figures are properly positioned in the receptacles 24, the figure switches 28 detect the presence of the game figures 16, and the participants may be prompted to begin selecting game figures.

Turning to FIG. 2, additional components that may be included on the base 14 of the game 10 are illustrated. In addition to the receptacles 24 with the figure switches 28, the base 14 may include a power switch 30 having a power-on position and a power-off position for activating and de-activating the electronic components of the game 10. The base 14 may further include a finish switch 32 that may be activated when a participant's game piece negotiates the spaces 20 to reach the finish switch 32 and to depress the finish switch 32 to conclude the game 10. In order to prompt the participants to take turns, and to inform of correct and incorrect selections, the base 14 may also include a speaker 34 to play instructions for the participants and to acknowledge correct and incorrect selections.

FIG. 3 is a block diagram of a number of components that may be incorporated in the matching game 10. Referring to FIG. 3, the matching game 10 may include a controller 36 containing the game logic and sound generation data implemented via circuitry contained on a conventional printed circuit board, with the game execution logic and sound generation data being stored directly on the printed circuit board. It should be appreciated that although the controller 36 may be implemented on a printed circuit board, more complex implementations of the matching game 10 may be implemented wherein the controller 36 may comprise, among other components, a program memory, a microcontroller or microprocessor (MP), a random-access memory (RAM), read-only memory (ROM) and an input/output (I/O) circuit, all of which may be interconnected. It should be appreciated that the controller 36 may include multiple microprocessors. Similarly, the memory of the controller 36 may include multiple RAMs and multiple program memories, depending on the complexity and requirements of a specific implementation. It should also be appreciated that the I/O circuit may include a number of different types of I/O circuits, such as sound generation circuits, video generation circuits, odor generation circuitry, and the like. The RAM(s), ROM(s) and program memories may be implemented as semiconductor memories, magnetically readable memories, and/or optically readable memories, for example.

FIG. 3 illustrates that the controller 36 may be operatively coupled to the figure switches 28, the power switch 30, the finish switch 32 and the speaker 34, each of those components being so coupled via a respective direct line or conductor. Different connection schemes could be used. In addition, the power switch 30 is operatively coupled to a power supply 38. When the power switch 30 is in the power-on position, the power supply 38 provides power to the controller 36, circuitry and other components 28, 32 and 34. Input signals produced by the switches 28, 32 are output to the controller 36 for processing by the game execution logic. Depending on the processing performed, the circuitry of the controller 36 generates and outputs sound generation signals to the speaker 32, wherein the speaker 32 translates the output signals into sounds which can be heard by the participants of the matching game 10. The general and specific technologies relating to electronic sound generation circuitry, and the software required to run such devices, are well known to those skilled in the electronic and software arts, and therefore the specific details of the digital processing and memory portions of such circuitry, and the specific details of any software required for this specific application will not be described further herein.

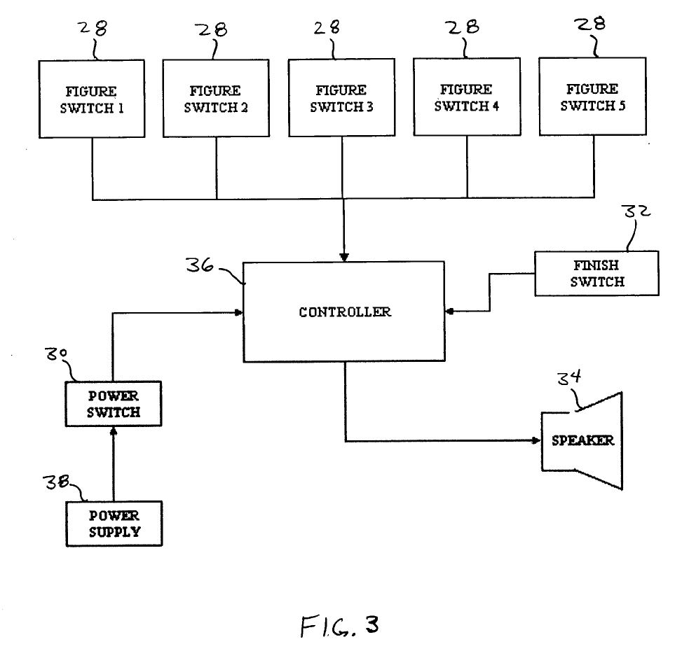

As previously discussed, the figure switches 28 detect the game figures 16 when the bottoms 26 are properly disposed in the receptacles 24 of the base 14. FIGS. 4-6 illustrate an embodiment of a figure switch 28 comprising an optical sensor transmitting a signal to the controller 36 indicating the presence of the game figure 16 when the bottom 26 of the game figure 16 covers the optical sensor. Referring to FIG. 4, the figure switch 28 is disposed in the receptacle 24 with a pair of wires 40 operatively connecting the figure switch 28 to the controller 36 (not shown). The game figure 16 is shown with the bottom 26 above the receptacle 24, such that the optical sensor of the figure switch 28 does not detect the presence of the game figure 16. In FIG. 5, the game figure 16 is properly positioned with the bottom 26 disposed within the receptacle 28 and covering the optical sensor of the figure switch 28. In this position, the figure switch 28 transmits an output signal to the controller 36 indicating the presence of the game figure 16. Finally, FIG. 6 illustrates the game figure 16 improperly positioned in the receptacle 24. As shown, a portion of the bottom 26 of the game figure 16 is resting on the edge of the receptacle 24 and, therefore, does not cover the figure switch 28. In this position, the figure switch 28 will not transmit an output signal indicating the presence of the game figure until the game figure 16 is properly positioned in the receptacle 24. While the figure switch 28 is discussed herein as transmitting an output signal to the controller 36 indicating the presence of the game figure 16, those skilled in the art will understand that the figure switches 28 may be configured to transmit a continuous output signal when the figure switches 28 do not detect the presence of the game figures 16, and discontinue the output signal when the game figures 16 are properly positioned in the receptacles 24, thereby informing the controller 36 of the presence of the game figure 16s by the absence of output signals from the figure switches 28.

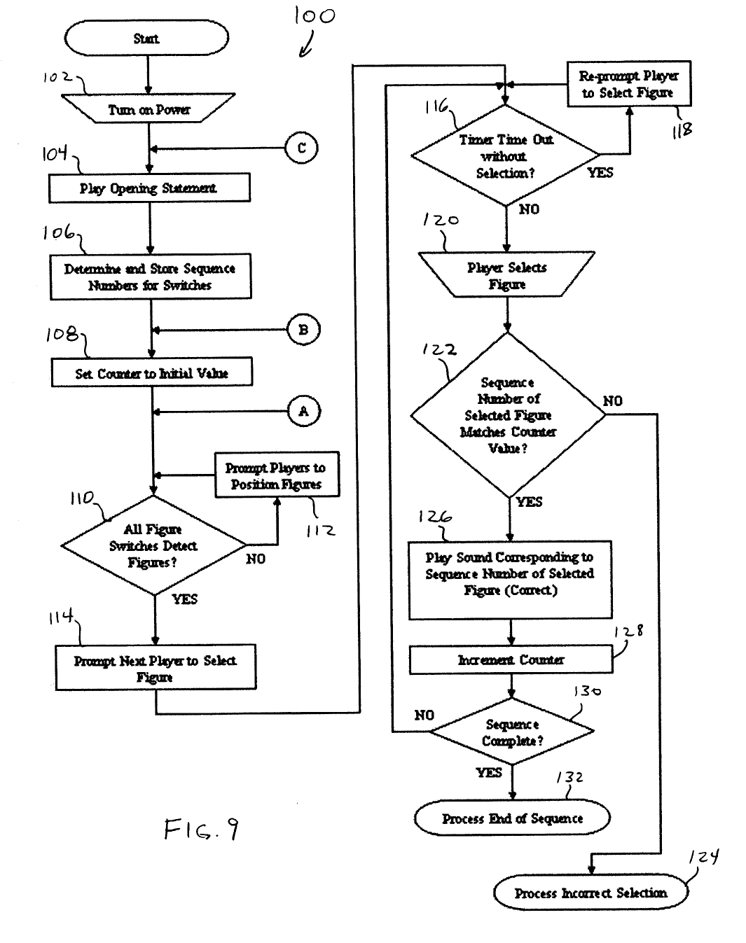

The finish switch 32 may be implemented via an optical sensor of the type described in the preceding paragraph. As an alternative, the finish switch 32 may be implemented via a switch that detects the pressure of a game piece 18 on the finish switch 32, or via a switch that detects displacement as a result of the game piece 18 depressing the finish switch 32. For example, as illustrated in FIGS. 7 and 8, a finish switch 32 detecting displacement may include a button 42 and wires 44 operatively connecting the finish switch 32 to the controller 36. In FIG. 7, the button 42 may have a normal position wherein the button 42 is elevated above the body of the finish switch 32 when not engaged by the base 46 of the game piece 18. Subsequently, as shown in FIG. 8, the base 46 of the game piece 18 engages the button 42 and depresses the button 42 toward the base of the finish switch 32, either under the weight of the game piece 18 or the downward force applied by the participant. In this position, the finish switch 32 may transmit an output signal to the controller 36 indicating that a participant has completed the matching game 10.

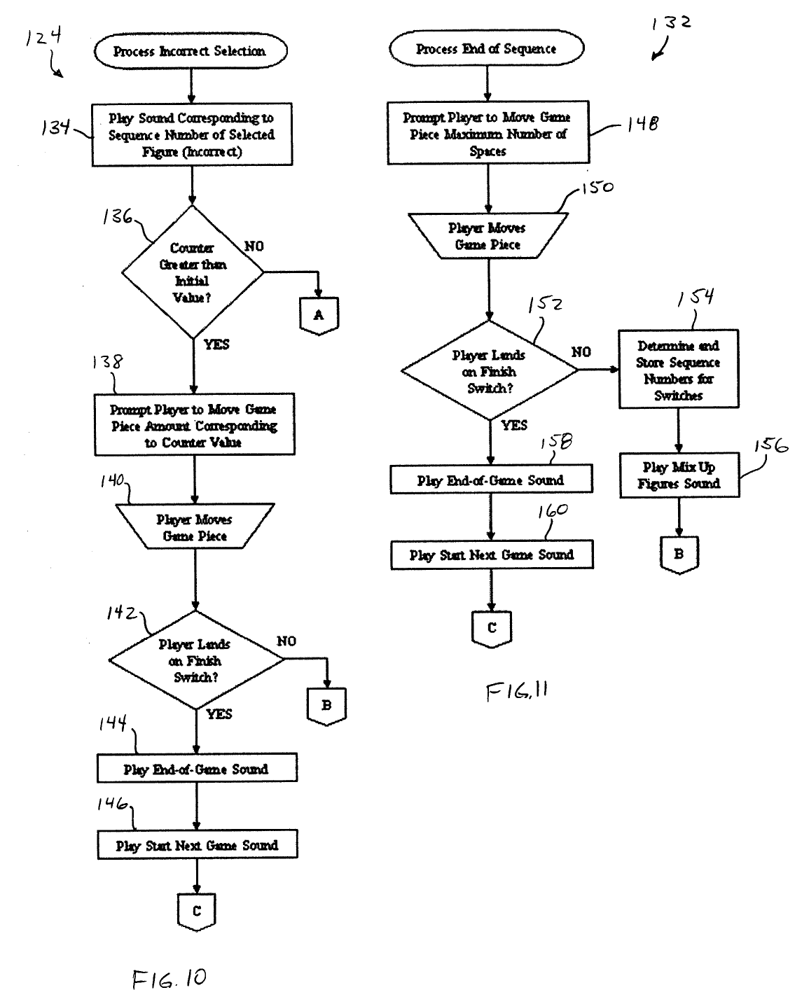

FIG. 9 is a flowchart of a main game play routine 100 that may be stored in the memory of the controller 36. Referring to FIG. 9, the main game play routine 100 may begin operation at block 102 wherein one of the participants may turn on the power to the matching game 10 by moving the power switch 30 to the power-on position. After the power switch 30 is set to the power-on position, control passes to a block 104 wherein the controller 36 may transmit output signals to the speaker 34 causing the speaker 34 to play an opening statement indicating the start of the matching game 10. At this point, the matching game 10 may be initialized to begin game play. One step in initializing the matching game 10 may occur at a block 106 wherein the controller 36 may determine the sequence numbers to be associated with each of the figure switches 28, and store the sequence numbers in the memory of the controller 36. Each figure switch 28 may be assigned a number ranging between one and the the total number of positions in the sequence that corresponds to a position in the sequence. For example, in a matching game 10 based on the “This Little Piggy Went to Market” nursery rhyme, the first figure switch 28 shown in FIG. 3 may be assigned a number between one and five corresponding to its position in the sequence. If the first figure switch 28 is assigned number three, the first figure switch 28 is associated with the “This little piggy had roast beef” line of the nursery rhyme. Once the sequence numbers are assigned to the figure switches 28, the initialization may be completed at a block 108 by setting a counter in the controller 36 to an initial value. As the game figures 16 are selected by the participants, the counter value may be compared to the sequence number of the figure switch 28 corresponding to the selected game figure 16 to determine whether the participant made a correct selection.

Once the matching game 10 is initialized, control may pass to a block 110 to determine whether all of the figure switches 28 detect the presence of game figures 16 in the receptacles 24. If one or more of the game figures 16 are not properly positioned in the receptacles 24, control may pass to a block 112 wherein the controller 36 may transmit output signals to the speaker 34 causing the speaker 34 to prompt the participants to properly position the game figures 16 in the receptacles 24. Control then passes back to the block 110 to again determine whether all of the figure switches 28 detect the presence of game figures 16 in the receptacles 24. Once all of the figure switches 28 detect the presence of game figures 16, control may pass to a block 114 so that the controller 36 may transmit output signals to the speaker 34 causing the speaker 34 to prompt the next participant to select one of the game figures 16.

After the next participant has been prompted to select one of the game figures 16, the controller 36 may set a timer for a predetermined time period within which a participant is required to select one of the game figures 16. If the timer times out at a block 116 without the participant selecting one of the game figures 16, control may pass to a block 116 wherein the controller 36 may transmit output signals to the speaker 34 causing the speaker 34 to re-prompt the participant to select one of the game figures 16. Eventually, the participant will select one of the game figures 28 at a block 120 by removing the game figure 16 from the corresponding receptacle 24. Once the game figure 16 is selected, the corresponding figure switch 28 may transmit an output signal to the controller 36 indicating that the selected game figure 16 has been removed.

Control then passes to a block 122 wherein the controller 36 may compare the sequence number stored for the figure switch 28 corresponding to the selected game figure 16 to the counter value to determine whether the participant selected the game figure 16 in the correct position in the sequence. For example, if the figure switch 28 is assigned a sequence number of one, then the counter must be set to its initial value for the participant to have made a correct selection. If the figure switch 28 is assigned a sequence number of three, then the counter must have a value corresponding to the third position in the sequence for the selection to be correct.

If the sequence number assigned to the figure switch 28 corresponding to the selected game figure 16 does not correspond to the counter value, control may pass to a process incorrect selection routine 124 to process the end of the participant's turn. If the sequence number corresponds to the counter value, control may pass to a block 126 wherein the controller 36 may transmit output signals to the speaker 34 causing the speaker 34 to play sounds for the correct selection of the sequence number assigned to the figure switch 28 corresponding to the selected game figure 16. After playing the correct selection sound for the sequence number, control may pass to a block 128 wherein the controller 36 may increment the counter in preparation for comparison to the sequence number assigned to the figure switch 28 corresponding to the next-selected game figure 16. Control then may pass to a block 130 for the controller 36 to determine whether the last selection by the participant has completed the sequence. The comparison may be implemented with the controller 36 comparing the current counter value to a predetermined value indicating that the sequence is complete. If the participant has completed the sequence, control may pass to a process end of sequence routine 132 to process the end of the participant's turn. If the sequence has not been completed, control may be returned to block 116 to reset the selection timer and await the participant's next selection of one of the game figures 16.

FIG. 10 is a flowchart of the process incorrect selection routine 124 referenced in FIG. 9 as being initiated if the controller 36 determines that the participant made an incorrect selection of a game figure 16 at block 122. Referring to FIG. 10, at block 134, the routine 124 may cause the controller 36 to transmit output signals to the speaker 34 causing the speaker 34 to play sounds for the incorrect selection of the sequence number assigned to the figure switch 28 corresponding to the selected game figure 16. After playing the sound for the incorrect selection, control may pass to a block 136 wherein the controller 36 may determine whether the player has made any correct selections of game figures 16 during his/her turn by comparing the current counter value to the initial counter value. If the current counter value is not greater than the initial counter value, the participant has not made any correct selections of game figures 16 and, consequently, is not entitled to move his/her game piece 18. If the participant has not made any correct selections, control returns to block 110 of the main game play routine 100 of FIG. 9 to ensure that the game figures 16 are properly positioned in the corresponding receptacles 24 and, subsequently, to block 114 to prompt the next player to select a game figure 16.

If the current counter value is greater than the initial counter value, control passes to a block 138 wherein the controller 36 may transmit output signals to the speaker 34 causing the speaker 34 to prompt the participant to move his/her game piece 18 by an amount of spaces corresponding to the number of correct selections of game figures 16 made by the participant during his/her turn. The participant moves his/her game piece by the prompted number of spaces at block 140, and may or may not reach the finish switch 32.

At a block 142, the controller 36 may detect whether the participant's game piece 18 has landed on and activated the finish switch 32. If the controller 36 does not detect the activation of the finish switch 32, control returns to block 108 of the main game play routine 100 of FIG. 9 to reset the counter to the initial value in preparation for the next participant's turn. If the controller 36 detects the activation of the finish switch 32 by the participant's game piece 18, control passes to a block 144 wherein the controller 36 may transmit output signals to the speaker 34 causing the speaker 34 to play an end-of-game sound indicating to the participants that the current participant has won the game. Subsequently, control passes to a block 146 wherein the controller 36 may transmit output signals to the speaker 34 causing the speaker 34 to play a start-next-game sound prior to returning control to block 104 of the main game play routine 100 to play the opening statement for the next game and initializing the matching game 10 for the next game.

FIG. 11 is a flowchart of the process end of sequence routine 128 referenced in FIG. 9 as being initiated if the controller 36 determines that the participant has completed the sequence of game figures 16 at block 130. Referring to FIG. 11, at block 148, the controller 36 may transmit output signals to the speaker 34 causing the speaker 34 to prompt the participant to move his/her game piece 18 by maximum number of spaces corresponding to the total number of selections of game figures 16 required to complete the sequence. The participant moves his/her game piece by the prompted number of spaces at block 150, and may or may not reach the finish switch 32.

At a block 152, the controller 36 may detect whether the participant's game piece 18 has landed on and activated the finish switch 32. If the controller 36 does not detect the activation of the finish switch 32, control passes to a block 154 wherein the controller 36 may determine anew the sequence numbers to be associated with each of the figure switches 28, and store the new sequence numbers in the memory of the controller 36. In the same manner as the previous matching game, each figure switch 28 may be assigned a number ranging between one and the the total number of positions in the sequence that corresponds to a position in the sequence. Once the sequence numbers are assigned to the figure switches 28, control passes to a block 156 wherein the controller 36 may transmit output signals to the speaker 34 causing the speaker 34 to prompt the participants to reposition or redistribute the game figures 16 in the receptacles 24. Finally, control returns to block 108 of the main game play routine 100 of FIG. 9 to reset the counter to the initial value in final preparation for the next participant's turn.

If the controller 36 detects the activation of the finish switch 32 by the participant's game piece 18, control passes to a block 158 wherein the controller 36 may transmit output signals to the speaker 34 causing the speaker 34 to play an end-of-game sound indicating to the participants that the current participant has won the game. Subsequently, control passes to a block 160 wherein the controller 36 may transmit output signals to the speaker 34 causing the speaker 34 to play a start-next-game sound prior to returning control to block 104 of the main game play routine 100 to play the opening statement for the next game and initializing the matching game 10 for the next game.

While the electronic sequence matching game 10 is illustrated in the drawing figures herein as being based on the “This Little Piggie Went to Market” nursery rhyme, with a corresponding configuration of the matching game 10 in terms of layout, images of the game figures 16 and game pieces 18, and number of selections in the sequence, it will be understood that the matching game 10 may have any configuration wherein a sequence is determined, the participants' make selections that are recognized by the matching game 10 and compared to the pre-determined sequence, and the participants are provided with perceptible feedback of the correctness or incorrectness of their selections.

What is claimed is:

1. An electronic sequence matching game wherein participants attempt to make selections in the correct sequential order for a sequence of a plurality of selections, the matching game comprising:
a plurality of game figures each having a different appearance;
a plurality of game pieces each having a different appearance;
a game board having a top surface with indicia thereon representing a plurality of spaces which the plurality of game pieces must traverse from a starting position to a finishing position during the course of a sequence matching game; and
a base comprising:
a plurality of receptacles each adapted to receive one of the game figures, with the number of receptacles being equal to the number of selections in the sequence;
a plurality of figure switches, each figure switch being disposed within one of the receptacles and being adapted to detect the absence of a game figure from the corresponding receptacle;
a finish switch being adapted to detect one of the game pieces being disposed thereby;
a speaker being adapted to output sounds;
a controller operatively coupled to the plurality of figure switches, the finish switch and the speaker,
the controller being programmed to determine sequence numbers associating each of the receptacles with one of the selections of the sequence, and to store the sequence numbers of the figure switches,
the controller being programmed to initialize a counter to an initial value,
the controller being programmed to prompt a participant to select one of the game figures,
the controller being programmed to compare the sequence number associated with a figure switch detecting the absence of the corresponding game figure to the counter value to determine whether the participant selected the game figure in the correct position in the sequence,
the controller being programmed to cause the speaker to output a correct selection sound corresponding to the sequence number associated with a figure switch detecting the absence of the corresponding game figure when the controller determines that the participant selected the game figure in the correct position in the sequence,
the controller being programmed to cause the speaker to output an incorrect selection sound corresponding to the sequence number associated with a figure switch detecting the absence of the corresponding game figure when the controller determines that the participant selected the game figure in an incorrect position in the sequence,
the controller being programmed to increment the counter value when the controller determines that the participant selected a game figure in the correct position in the sequence,
the controller being programmed to determine whether the counter value is equal to a maximum value corresponding to the number of selections in the sequence,
the controller being programmed to cause the speaker to output a prompt sound instructing a participant to move one of the game pieces a number of spaces corresponding to the counter value after one of the controller determining that the participant selected a game figure in an incorrect position in the sequence and the controller determing that the counter value is equal to the maximum value, and
the controller being programmed to cause the speaker to output an end-of-game sound when the finish switch detects one of the game pieces being disposed thereby.

2. An electronic sequence matching game as defined in claim 1, wherein each of the plurality of figure switches comprises an optical sensor.

3. An electronic sequence matching game as defined in claim 1, wherein each of the plurality of figure switches comprises a pressure sensor.

4. An electronic sequence matching game as defined in claim 1, wherein each of the plurality of figure switches comprises a displacement sensor.

5. An electronic sequence matching game as defined in claim 1, wherein the finish switch comprises an optical sensor.

6. An electronic sequence matching game as defined in claim 1, wherein the finish switch comprises a pressure sensor.

7. An electronic sequence matching game as defined in claim 1, wherein the finish switch comprises a displacement sensor.

8. An electronic sequence matching game as defined in claim 1, wherein the controller comprises circuitry on a printed circuit board.

9. An electronic sequence matching game wherein participants attempt to make selections in the correct sequential order for a sequence of a plurality of selections, the matching game comprising:
a plurality of game figures;
a plurality of receptacles each adapted to receive one of the game figures, with the number of receptacles being equal to the number of selections in the sequence;
a plurality of figure switches, each figure switch being disposed within one of the receptacles and being adapted to detect the absence of a game figure from the corresponding receptacle;
a speaker being adapted to output sounds;
a controller operatively coupled to the plurality of figure switches and the speaker,
the controller being programmed to determine sequence numbers associating each of the receptacles with one of the selections of the sequence, and to store the sequence numbers of the figure switches,
the controller being programmed to initialize a counter to an initial value,
the controller being programmed to prompt a participant to select one of the game figures,
the controller being programmed to compare the sequence number associated with a figure switch detecting the absence of the corresponding game figure to the counter value to determine whether the participant selected the game figure in the correct position in the sequence,
the controller being programmed to cause the speaker to output a correct selection sound corresponding to the sequence number associated with a figure switch detecting the absence of the corresponding game figure when the controller determines that the participant selected the game figure in the correct position in the sequence,
the controller being programmed to cause the speaker to output an incorrect selection sound corresponding to the sequence number associated with a figure switch detecting the absence of the corresponding game figure when the controller determines that the participant selected the game figure in an incorrect position in the sequence,
the controller being programmed to increment the counter value when the controller determines that the participant selected a game figure in the correct position in the sequence.

10. An electronic sequence matching game as defined in claim 9, further comprising:
a plurality of game pieces each having a different appearance;.
a game board having a top surface with indicia thereon representing a plurality of spaces which the plurality of game pieces must traverse from a starting position to a finishing position during the course of a sequence matching game; and
the controller being programmed to cause the speaker to output a prompt sound instructing a participant to move one of the game pieces a number of spaces corresponding to the counter value after the controller determines that the participant selected a game figure in an incorrect position in the sequence.

11. An electronic sequence matching game as defined in claim 10, wherein the controller is programmed to determine whether the counter value is equal to a maximum value corresponding to the number of selections in the sequence, and wherein the controller is programmed to cause the speaker to output a prompt sound instructing a participant to move one of the game pieces a number of spaces corresponding to the counter value after the controller determines that the counter value is equal to the maximum value.

12. An electronic sequence matching game as defined in claim 9, further comprising:
a plurality of game pieces each having a different appearance; and
a finish switch being adapted to detect one of the game pieces being disposed thereby;
wherein the controller is programmed to cause the speaker to output an end-of-game sound when the finish switch detects one of the game pieces being disposed thereby.

13. An electronic sequence matching game as defined in claim 12, wherein the finish switch comprises a displacement sensor.

14. An electronic sequence matching game as defined in claim 9, wherein each of the plurality of figure switches comprises an optical sensor.

15. An electronic sequence matching game as defined in claim 9, wherein the controller comprises circuitry on a printed circuit board.

16. A method of game play for an electronic sequence matching game wherein participants attempt to make selections in the correct sequential order for a sequence of a plurality of selections, the method comprising:
providing a plurality of game figures and a plurality of receptacles adapted to receive one of the game figures, the number of receptacles being equal to the number of selections in the sequence;
determining sequence numbers associating each of the receptacles with one of the selections of the sequence;
storing the sequence numbers of the receptacles;
initializing a counter to an initial value;
prompting a participant to select one of the game figures;
determining whether a participant selected a game figure in the correct position in the sequence by comparing the sequence number of the receptacle corresponding to the selected game figure to the counter value;
outputting a correct selection sound corresponding to the sequence number associated with the receptacle corresponding to the selected game figure after determining that the participant selected the game figure in the correct position in the sequence,
outputting an incorrect selection sound corresponding to the sequence number associated with the receptacle corresponding to the selected game figure after determining that the participant selected the game figure in the incorrect position in the sequence,
incrementing the counter value after determining that the participant selected the game figure in the correct position in the sequence.

17. A method of game play for an electronic sequence matching game as defined in claim 16, further comprising prompting a participant to move a game piece a number of spaces corresponding to the counter value after determining that the participant selected a game figure in an incorrect position in the sequence.

18. A method of game play for an electronic sequence matching game as defined in claim 17, further comprising:
determining whether the counter value is equal to a maximum value; and
prompting a participant to move a game piece a maximum number of spaces when the counter value is equal to the maximum value.

19. A method of game, play for an electronic sequence matching game as defined in claim 16, further comprising outputting an end-of-game sound when a participant disposes a game piece at a finish position.

20. A method of game play for an electronic sequence matching game as defined in claim 19, further comprising determining that a game piece is disposed at a finish position via a displacement sensor.

21. A method of game play for an electronic sequence matching game as defined in claim 16, further comprising determining that a participant selected a game figure via an optical sensor.
